(19) United States
(12) Patent Application Publication
(10) Pub. No.: US 2011/0291884 A1
(43) Pub. Date: Dec. 1, 2011

(54) METHOD AND APPARATUS FOR DETERMINING ACCURACY OF LOCATION INFORMATION

(75) Inventors: Ji-Heon Oh, Yongin-si (KR); Hyun-Su Hong, Seongnam-si (KR); Gye-Joong Shin, Seongnam-si (KR); Kyong-Ha Park, Suwon-si (KR); Sung-Min Park, Seoul (KR)

(73) Assignee: Samsung Electronics Co., Ltd., Suwon-si (KR)

(21) Appl. No.: 13/118,754

(22) Filed: May 31, 2011

(30) Foreign Application Priority Data
May 31, 2010 (KR) 10-2010-0051400

(51) Int. Cl. G01S 19/48

(52) U.S. Cl. 342/357.31

(57) ABSTRACT

A method and apparatus for determining accuracy information of location information. The method includes receiving Global Positioning System (GPS) location information of a user terminal from a GPS, determining whether the user terminal enters into a GPS shadow area, checking terminal movement information including a moving speed and a moving direction of the user terminal, when the user terminal enters into the GPS shadow area, estimating location information of the user terminal based on the terminal movement information, checking auxiliary location information including a moving state of the user terminal, error information of a terrestrial magnetism sensor, and the moving speed of the user terminal, and determining the accuracy information based on an accumulated location error of the estimated location information, based on the auxiliary location information.

### PRIORITY

This application claims priority under 35 U.S.C. §119 to an application filed in the Korean Intellectual Property Office on May 31, 2010 and assigned Serial No. 10-2010-0051400, the content of which is incorporated herein by reference.

### BACKGROUND OF THE INVENTION

1. Field of the Invention

The present invention relates generally to navigation technology, and more particularly, to a method and apparatus for determining accuracy information for a location estimated in a Global Positioning System (GPS) shadow area.

2. Description of the Related Art

In general, a pedestrian navigation system uses GPS location information provided from GPS. However, when a user enters into a shadow area wherein a GPS signal cannot be received, the pedestrian navigation system estimates a location in the shadow area based on valid GPS location information received before the user entered into the shadow area.

A conventional pedestrian navigation system provides location information estimated in a Pedestrian Dead Reckoning (PDR) method or provides limited location information based on a time passed and/or distance traveled after a user enters into a shadow area until GPS location information is valid again by passing through the shadow area, i.e., while the user is located in the shadow area.

Position measurement technology using the PDR method acquires a relative location and a moving direction using previous location information and involves a moving distance and direction of a moving body using a sensor, such as a terrestrial magnetism sensor, for sensing a heading direction of a terminal and a sensor, such as an acceleration sensor, for sensing straight-line movement of the terminal.

Because the PDR method estimates a moving distance and direction of a user, an error may occur in location information according to a surrounding environment change, a moving time, a moving speed, a terminal moving state, and a sensor tolerance. However, because the PDR method estimates location information in a shadow area without considering these errors, reliability of the location information in the shadow area is often low.

### SUMMARY OF THE INVENTION

Accordingly, present invention is designed to substantially solve at least the above-described problems and/or disadvantages and to provide at least the advantages below.

An aspect of the present invention is to provide a method and apparatus for determining the accuracy of estimated location information in a shadow area.

Another aspect of the present invention is to provide a method and apparatus for providing reliable location information by considering location information estimated in a shadow area and accuracy of the location information.

Another aspect of the present invention is to provide a method and apparatus for providing a switching criterion of indoor location information determination modules for determining indoor location information in a shadow area.

In accordance with an aspect of the present invention, a method is provided for determining accuracy of location information. The method includes receiving GPS location information of a user terminal from a GPS; determining whether the user terminal enters into a GPS shadow area; checking terminal movement information containing a moving speed and a moving direction of the user terminal, when the user terminal enters into the GPS shadow area; estimating location information of the user terminal based on the terminal movement information in the GPS shadow area; checking auxiliary location information including a moving state of the user terminal, error information of a terrestrial magnetism sensor, and the moving speed of the user terminal; and determining the accuracy information based on an accumulated location error of the estimated location information, based on the auxiliary location information.

In accordance with another aspect of the present invention, an apparatus is provided for determining accuracy of location information. The apparatus includes a shadow area determiner for receiving GPS location information of a user terminal from a GPS and determining whether the user terminal enters into a GPS shadow area; a location information estimator for checking terminal movement information containing a moving speed and a moving direction of the user terminal and estimating location information of the user terminal based on the terminal movement information in the GPS shadow area; and an accuracy estimator for checking auxiliary location information including a moving state of the user terminal, error information of a terrestrial magnetism sensor, and the moving speed of the user terminal, and determining the accuracy information based on an accumulated location error of the estimated location information, based on the auxiliary location information.

In accordance with another aspect of the present invention, a user terminal is provided including a location information determination module including a GPS module for determining GPS location information of the user terminal from a GPS; a sensor unit for sensing acceleration information and azimuth information required to estimate location information in a shadow area and accuracy of the location information; a controller for determining whether the user terminal enters into a GPS shadow area, estimating location information of the user terminal in the GPS shadow area, checking auxiliary location information containing a moving state of the user terminal, error information of a terrestrial magnetism sensor, and a moving speed of the user terminal, and determining accuracy directing an accumulated location error of the estimated location information based on the auxiliary location information; a memory for storing the GPS location information, the estimated location information, and the accuracy generated by the location information determination module and the controller; and a timer for generating an operation event signal in predetermined intervals and providing the operation event signal to the sensor unit and the controller.

### BRIEF DESCRIPTION OF THE DRAWINGS

The above and other aspects, features, and advantages of the present invention will become more apparent from the following detailed description when taken in conjunction with the accompanying drawings, in which:

FIG. 1 is a block diagram illustrating a user terminal according to an embodiment of the present invention;

FIG. 2 is a block diagram illustrating a controller of a user terminal according to an embodiment of the present invention;

FIGS. 3A and 3B illustrate moving states of a user terminal, according to an embodiment of the present invention;

FIG. 4 is a flowchart illustrating a method of determining accuracy of location information, according to an embodiment of the present invention; and

FIG. 5 is a flowchart illustrating step 421 of FIG. 4.

### DETAILED DESCRIPTION OF EMBODIMENTS OF THE PRESENT INVENTION

Various embodiments of the present invention will be described in detail herein below with reference to the accompanying drawings. In the following description, although many specific items are shown, they are only provided to help general understanding of the present invention, and it will be understood by those of ordinary skill in the art that these specific items can be modified or changed within the scope of the present invention.

In the present invention, GPS location information indicates a location of a user terminal through data provided from a GPS, and the location information indicates location information of a user terminal, which is estimated using information provided from an acceleration sensor and a terrestrial magnetism sensor. In addition, indoor location information indicates information indicating a location of a user terminal, which is determined using a Wi-Fi Positioning System (WPS) module, a cell based location information providing module for providing location information based on a cell of a mobile communication network, and a sensor based location information providing module for providing location information of the user terminal using Bluetooth®, ZigBee®, an infrared sensor, an ultrasonic sensor, and a Radio Frequency Identification (RFID) sensor.

In the present invention, accuracy information is used for directing an accumulated location error of the estimated location information, wherein the accumulated location error is high when the accuracy of the accuracy information is high, and the accumulated location error is low when the accuracy of the accuracy information is low. Thus, in accordance with an embodiment of the present invention, reliability of the location information is low when the accuracy of the accuracy information of the location information is high, and the reliability of the location information is high when the accuracy of the accuracy information of the location information is low.

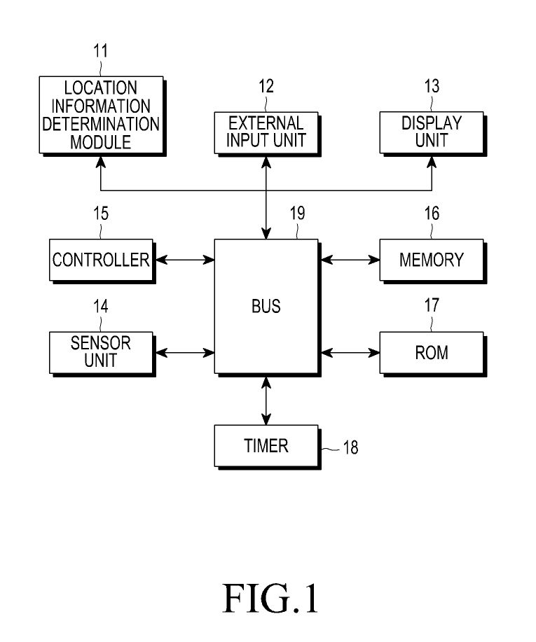

FIG. 1 is a block diagram illustrating a user terminal according to an embodiment of the present invention.

Referring to FIG. 1, the user terminal includes a location information determination module 11, an external input unit 12, a display unit 13, a sensor unit 14, a controller 15, a memory 16, a Read Only Memory (ROM) 17, and a timer 18.

The location information determination module 11 includes a GPS module for receiving location information from a GPS. Further, the location information determination module 11 may include a WPS module for determining location information using information regarding a wireless Access Point (AP) through Wi-Fi, a cell based location information providing module for providing location information based on a cell of a mobile communication network, and/or a sensor based location information providing module for providing location information of the user terminal using Bluetooth®, ZigBee®, an infrared sensor, an ultrasonic sensor, and/or an RFID sensor.

The external input unit 12 is a device for inputting numbers, character information, and function setting commands, etc., and outputs an input signal to the controller 15. For example, the external input unit 12 can be a keypad or touch screen.

The display unit 13 includes a display device, e.g., a Liquid Crystal Display (LCD), and displays information to a user, e.g., location information or a map.

The sensor unit 14 senses information for estimating location information in a shadow area and accuracy information of the location information. The sensor unit 14 may include an acceleration sensor for sensing acceleration information of the user terminal in order to detect a moving speed of the user terminal, a terrestrial magnetism sensor for sensing azimuth information for estimating a moving direction of the user, an altimeter sensor for sensing altitude information of the user, and a gyro sensor for sensing angular velocity information.

The controller 15 performs controls the general operations of the user terminal by generally controlling the function units described above. For example, the controller 15 processes location information provided from the location information determination module 11 (e.g., a GPS module), and outputs the location information and a map stored in the memory 16 through the display unit 13.

In addition, the controller 15 checks reception sensitivity of the location information provided from the GPS module and determines whether the user terminal is located in a shadow area. If the controller 15 determines that the user terminal is located in a shadow area, the controller 15 estimates location information by using information provided from the sensor unit 14 at predetermined intervals and estimates accuracy information of the estimated location information. The location information and the accuracy information estimated by the controller 15 are stored in the memory 16.

The ROM 17 stores information, a toleration, and offset information of at least one of the sensors included in the sensor unit 14, and the controller 15 uses the sensor related information stored in the ROM 17 to compensate for values sensed by the sensors when the location information or the accuracy information is estimated.

The timer 18 provides operation timings of the controller 15 by creating an event at predetermined times for estimating the location information and the accuracy information. Preferably, the sensor unit 14 provides only enough information required to estimate location information and accuracy information. That is, to prevent unnecessary power consumption in the sensor unit 14, the sensor unit 14 receives an operation timing from the timer 18, senses information required to estimate location information and accuracy information according to the operation timing, and provides the sensed information to the controller 15.

A bus 19 provides interfaces, e.g., Inter-Integrated Circuit (I2C), Universal Asynchronous Receiver/Transmitter (UART), and System Packet Interface (SPI), for connecting the controller 15 and the function units to each other.

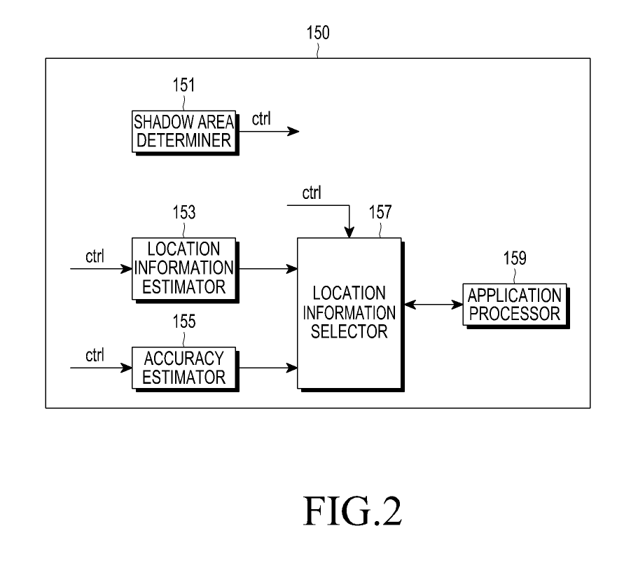

FIG. 2 is a block diagram illustrating a controller of a user terminal according to an embodiment of the present invention.

Referring to FIG. 2, a controller 150 includes a shadow area determiner 151, a location information estimator 153, an accuracy estimator 155, a location information selector 157, and an application processor 159.

The shadow area determiner 151 receives reception sensitivity of location information, e.g., the number of available GPS satellites and reception intensity values thereof, provided from the GPS module of the location information determination module 11 and determines, by checking the reception sensitivity of location information, whether the user terminal is located in a shadow area. If the shadow area determiner 151 determines that the user terminal is located in a shadow area, the shadow area determiner 151 outputs a control signal (ctrl) for directing an operation start, such that the location information estimator 153, the accuracy estimator 155, and the location information selector 157 start their respective operations.

Although not illustrated in FIG. 2, the shadow area determiner 151 also provides the control signal (ctrl) to the timer 18, such that the location information estimator 153 and the accuracy estimator 155 operate at predetermined times, and provides the control signal (ctrl) to the sensor unit 14, such that information required to estimate location information and accuracy information is provided to the location information estimator 153 and the accuracy estimator 155.

Using the control signal (ctrl) of the shadow area determiner 151, the location information estimator 153, the accuracy estimator 155, the location information selector 157, the sensor unit 14, and the timer 18 start their respective operations.

Because the timer 18 provides an operation event signal to the sensor unit 14, the location information estimator 153, the accuracy estimator 155, and the location information selector 157 at predetermined times, the sensor unit 14 provides the information required to estimate location information and accuracy information to the location information estimator 153 and the accuracy estimator 155 at the predetermined times. Accordingly, the location information estimator 153 and the accuracy estimator 155 then estimate the location information and the accuracy information at the predetermined times.

Because GPS location information that was acquired before the GPS module of the location information determination module 11 entered into a shadow area is stored in the memory 16, the location information estimator 153 estimates a location of a user by calculating a relative location of the user moving in the shadow area, based on the GPS location information stored in the memory 16.

More specifically, the location information estimator 153 estimates terminal movement information including a moving speed and a moving direction of the user terminal by using information provided from the acceleration sensor and the terrestrial magnetism sensor of the sensor unit 14 at predetermined times. That is, the location information estimator 153 determines a moving state of the user terminal and calculates a moving speed of the user based on the information from the acceleration sensor, and then acquires data validity of the terrestrial magnetism sensor and azimuth information using the information from the terrestrial magnetism sensor. The location information estimator 153 estimates a current location information of the user by reflecting the azimuth information in the estimated moving direction of the user and the moving speed information onto the GPS location information stored in the memory 16.

Further, the location information estimator 153 may compensate for the information from the acceleration sensor and the terrestrial magnetism sensor by using the sensor offset information and the sensor tolerance information, which are stored in the ROM 17.

The accuracy estimator 155 sets an error reflected threshold by basically considering a moving state of the user terminal, the data validity of the terrestrial magnetism sensor, and auxiliary location information including the moving speed of the user (or the user terminal). Thereafter, the accuracy estimator 155 estimates accuracy of the estimated location information.

The moving state of the user terminal indicates whether the user terminal is parallel or orthogonal to the surface of the earth. If the user terminal is parallel to the surface of the earth, azimuth information acquired from the terrestrial magnetism sensor has a relatively small error. However, if the user terminal is orthogonal to the surface of the earth, azimuth information acquired from the terrestrial magnetism sensor has a relatively large error. Thus, an error rate is applied differently, according to a moving state of the user terminal.

Further, in accordance with an embodiment of the present invention, the user terminal being parallel to the surface of the earth does not necessarily indicate that the user terminal is completely parallel to the surface of the earth, but indicates that the user terminal is almost parallel to the surface of the earth to determine an azimuth error of the terrestrial magnetism sensor included in the user terminal. Likewise, in accordance with another embodiment of the present invention, the user terminal being orthogonal to the surface of the earth does not necessarily mean that the user terminal is completely orthogonal to the surface of the earth, but indicates that the user terminal is almost orthogonal to the surface of the earth.

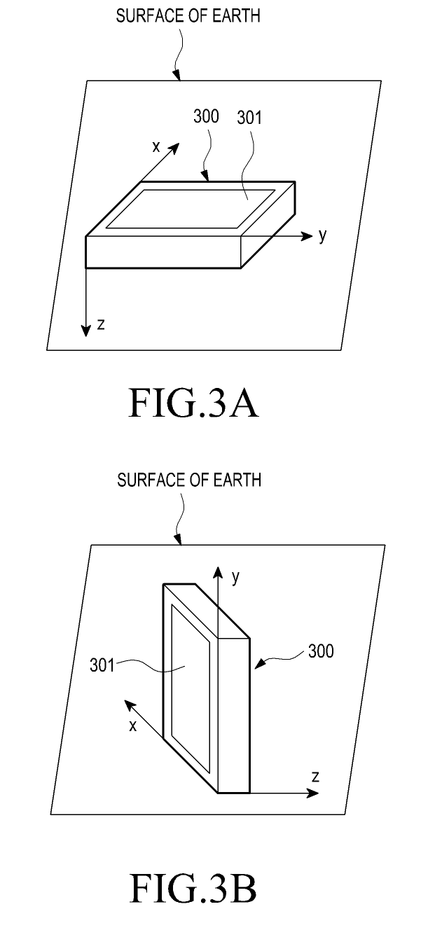

FIGS. 3A and 3B illustrate moving states of a user terminal, according to an embodiment of the present invention.

For example, FIG. 3A illustrates a user terminal 300, which is parallel to the surface of the earth. That is, if a display unit 301 of the user terminal 300 is parallel to the surface of the earth, when a user moves, the user terminal 300 moves in an x- or y-axis direction, and thus, an acceleration value in the x- or y-axis direction may be relatively larger than that in a z-axis direction.

On the contrary, as illustrated in FIG. 3B, if the display unit 301 of the user terminal 300 is orthogonal to the surface of the earth, when the user moves, the user terminal 300 moves in the x- or z-axis direction, and thus an acceleration value in the x- or z-axis direction may be relatively larger than that in the y-axis direction. Accordingly, the accuracy estimator 155 may determine a moving state of the user terminal by calculating acceleration values in the x-, y-, and z-axes directions, which are sensed through the acceleration sensor.

The terrestrial magnetism sensor for outputting azimuth information by sensing magnetism of the Earth may have an error in the azimuth information according to an electromagnetic field state in an environment of the terrestrial magnetism sensor. Thus, the accuracy estimator 155 determines validity of the data output from the terrestrial magnetism sensor by real-time checking a current state of the terrestrial magnetism sensor and applies a different error rate according to the current state of the terrestrial magnetism sensor when accuracy information is calculated.

As a moving speed of the user terminal is high, a moving distance of the user terminal is large, and a difference between the moving distance of the user terminal and an actual moving distance thereof occurs, so a different error rate may be applied according to the moving speed. Accordingly, the accuracy estimator 155 measures a moving speed of the user terminal by using the acceleration sensor and differently sets an error rate according to the moving speed.

In addition, because the user terminal may continuously move or may stop after moving a predetermined distance, the auxiliary location information may further include a dispersion value of a moving speed of the user terminal. Accordingly, the accuracy estimator 155 may further check the dispersion value of the moving speed and compensate for an error rate of the moving speed by using the dispersion value of the moving speed when the user terminal moves continuously.

As a predetermined interval for estimating location information may be long, information acquired from the sensors cannot be immediately reflected, and an average value of information accumulated for a predetermined time is reflected, so an error of an estimated location is large. Accordingly, the auxiliary location information may further include a length of the predetermined interval, and the accuracy estimator 155 may further check the length of the predetermined period of time and differently sets an error rate according to the length of the predetermined interval.

The auxiliary location information may further include errors of the sensors included in the sensor unit 14, and the accuracy estimator 155 may estimate accuracy information by further reflecting the errors of the sensors. In addition, the accuracy estimator 155 may estimate accuracy information by further reflecting a moving time of the user to increase an error of an estimated location, even when movement of the user is not detected (e.g., in an elevator or escalator). Thus, the auxiliary location information may further include the moving time of the user.

Further, the accuracy estimator 155 may compensate for azimuth information of the terrestrial magnetism sensor, which rapidly changes according to a surrounding environment, by checking a change value of angular velocity information of the gyro sensor and may further reflect an error component according to a height change of the user by checking altitude information from the altimeter sensor to measure a height change component occurring when the user moves, e.g., by using an elevator, an escalator, or stairs, in a shadow area. Accordingly, the auxiliary location information may further include the change value of the angular velocity information and/or the altitude information.

When the control signal (ctrl) is not received from the shadow area determiner 151, the location information selector 157 provides the GPS location information received from the GPS module to the application processor 159. When the control signal (ctrl) for directing that a location of the user is in a shadow area is received from the shadow area determiner 151, the location information selector 157 provides the location information received from the location information estimator 153 to the application processor 159.

The location information selector 157 determines whether the location information estimated by the location information estimator 153 is to be used, by using the accuracy information received from the accuracy estimator 155. For example, if the accuracy information received from the accuracy estimator 155 is greater than a predetermined threshold, the location information selector 157 may provide previously estimated location information or location information received from indoor location information determination modules, e.g., a WPS module, a cell based location information providing module, or a sensor based location information providing module, included in the location information determination module 11, without using the currently estimated location information.

The application processor 159 drives an application, such as Navigation or Geo-Tagging, using location information and provides data generated by the application to the display unit 13. The application processor 159 may receive the GPS location information or the location information selected by the location information selector 157 and provide the data generated by the application together with the GPS location information or the location information to the display unit 13. The application processor 159 may further provide information provided by the accuracy estimator 155 to the display unit 13. Accordingly, the application processor 159 may provide the accuracy information as digitized data (e.g., meters or the number of steps) or provide the accuracy information by adding a User Interface (UI) element, such as a level bar, a block, or a circle. Accordingly, a user may intuitively determine how reliable the location information estimated in the shadow area is.

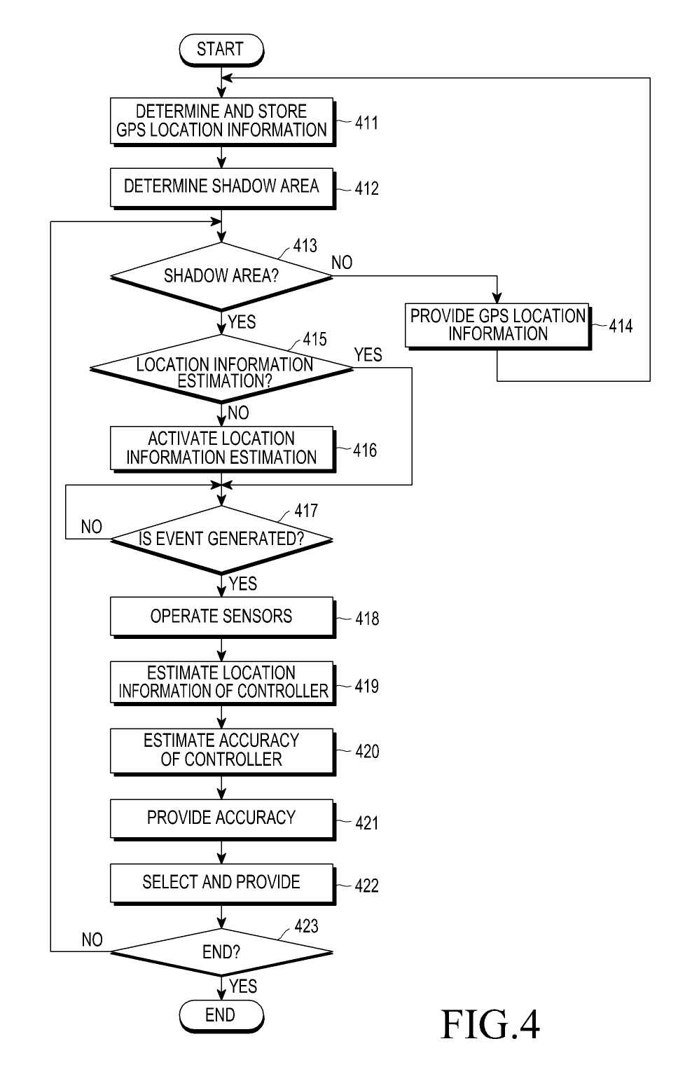

FIG. 4 is a flowchart illustrating a method of determining the accuracy of location information, according to an embodiment of the present invention.

Referring to FIG. 4, in step 411, the GPS module included in the location information determination module 11 detects GPS location information and stores the GPS location information in the memory 16. Here, the GPS module may further store reception sensitivity, e.g., the number of available GPS satellites and reception intensity values thereof, together with the GPS location information.

In step 412, the shadow area determiner 151 of the controller 15 determines whether the user terminal is located in a shadow area, based on the reception sensitivity stored in the memory 16.

If the user terminal is not located in a shadow area in step 413, in step 414, the shadow area determiner 151 transmits the control signal (ctrl) to the location information selector 157, controlling the location information selector 157 to provide the GPS location information to the application processor 159.

However, if the user terminal is located in a shadow area in step 413, in step 415, the shadow area determiner 151 determines whether the location information estimator 153, the accuracy estimator 155, and the location information selector 157 have started their operations.

If the location information estimator 153, the accuracy estimator 155, and the location information selector 157 have not started their operations in step 415, this indicates that location information has not been estimated in the shadow area, and in step 416, the shadow area determiner 151 outputs the control signal (ctrl) for directing an operation start to the timer 18, the sensor unit 14, the location information estimator 153, the accuracy estimator 155, and the location information selector 157 to determine location information at predetermined times. Accordingly, the timer 18, the sensor unit 14, the location information estimator 153, the accuracy estimator 155, and the location information selector 157 start their operations.

If the location information estimator 153, the accuracy estimator 155, and the location information selector 157 have started their operations in step 415, this indicates that location information has been estimated in the shadow area, i.e., the timer 18, the sensor unit 14, the location information estimator 153, the accuracy estimator 155, and the location information selector 157 have already started their operations.

The timer 18 generates an operation event signal for determining location information at predetermined times, and the operation event signal is provided to the sensor unit 14, the location information estimator 153, the accuracy estimator 155, and the location information selector 157. Thus, if the operation event signal is generated by the timer 18 in step 417, steps 418 to 422 are performed to estimate location information. Because the timer 18 generates the operation event signal at the predetermined times, steps 417 to 422 may be performed repeatedly until determination of location information ends in step 423.

In step 418, when the operation event signal from the timer 18 is input to the sensor unit 14, the sensor unit 14 performs its operation to sense information required to estimate location information in the shadow area and accuracy information of the location information. For example, the sensor unit 14 checks measurement values of an acceleration sensor for sensing acceleration information of the user terminal to detect a moving speed of the user terminal, a terrestrial magnetism sensor for sensing azimuth information required to estimate a moving direction of the user, an altimeter sensor for sensing altitude information of the user, and a gyro sensor for sensing angular velocity information, which are included in the sensor unit 14, and provides the measurement values to the location information estimator 153 and the accuracy estimator 155 of the controller 15.

In step 419, the location information estimator 153 determines terminal movement information including a moving speed and a moving direction of the user terminal by using the information provided from the acceleration sensor and the terrestrial magnetism sensor of the sensor unit 14 at the predetermined times. That is, the location information estimator 153 determines a moving state of the user terminal and calculates a moving speed of the user through the information of the acceleration sensor and acquires validity of terrestrial magnetism sensor data and azimuth information through the information from the terrestrial magnetism sensor. The location information estimator 153 estimates current location information of the user by reflecting the azimuth information in the estimated moving direction of the user and the moving speed information onto the GPS location information stored in the memory 16.

Here, the location information estimator 153 may compensate for the information from the acceleration sensor and the terrestrial magnetism sensor by reflecting sensor offset information and sensor tolerance information, which are stored in the ROM 17.

In step 420, the accuracy estimator 155 sets an error reflected threshold by basically considering a moving state of the user terminal of the user, the data validity of the terrestrial magnetism sensor, and auxiliary location information containing the moving speed of the user (or the user terminal) and estimates accuracy information for the estimated location information. In addition the accuracy estimator 155 may estimate the accuracy information by further using at least one of a dispersion value of the moving speed, the predetermined period of time used to estimate location information, errors of the sensors included in the sensor unit 14, a moving time of the user, a change value of angular velocity information of the gyro sensor, and altitude information of the altimeter sensor.

In step 421, the location information selector 157 receives location information from the location information estimator 153 and accuracy information from the accuracy estimator 155 and determines by using the accuracy information whether the location information is to be used. For example, if the accuracy information received from the accuracy estimator 155 is greater than a predetermined threshold, the location information selector 157 may provide previously estimated location information or previously stored location information to the application processor 159 without using currently estimated location information. Accordingly, the application processor 159 may drive an application, such as Navigation or Geo-Tagging, using location information and provide data generated by the application together with the GPS location information or the estimated location information.

Further, the location information selector 157 may provide the accuracy information together with the estimated location information to the application processor 159. For example, the application processor 159 may provide the accuracy information as digitized data (e.g., meters or the number of steps) or provide the accuracy information by adding a User Interface (UI) element, such as a level bar, a block, or a circle. Accordingly, the user may intuitively determine how reliable the location information estimated in the shadow area is.

Although the location information selector 157 is described above as determining whether the location is to be used based on the accuracy information, the present invention is not limited thereto. Alternatively, the location information selector 157 may provide location information provided from at least one of indoor location information determination modules, e.g., a WPS module, a cell based location information providing module, and/or a sensor based location information providing module, included in the location information determination module 11 based on the accuracy information.

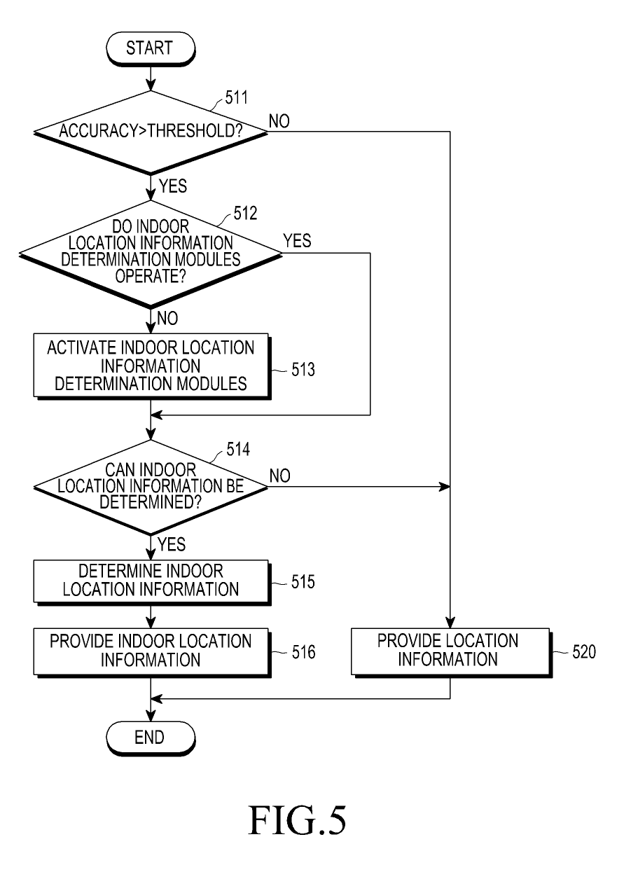

FIG. 5 is a flowchart illustrating step 421 of FIG. 4.

Referring to FIG. 5, in step 511, the location information selector 157 determines whether the accuracy information is greater than the predetermined threshold. If the accuracy information is greater than the predetermined threshold, an accumulated error of the location information is relatively large, so the reliability of the location information is relatively low. However, if the accuracy information is less than or equal to the predetermined threshold, an accumulated error of the location information is relatively small, so the reliability of the location information is relatively high. Thus, if the accuracy is less than or equal to the predetermined threshold, the location information selector 157 provides the estimated location information to the application processor 159 in step 520, such that the application processor 159 provides the estimated location information to the user.

However, if the accuracy is greater than the predetermined threshold, in step 512, the location information selector 157 determines whether the indoor location information determination modules included in the location information determination module 11 are operating. If the indoor location information determination modules are not operating, the location information selector 157 activates the indoor location information determination modules in step 513.

Because a predetermined time is required to provide indoor location information, even if the indoor location information determination modules are activated, the indoor location information may not be immediately provided. Accordingly, in step 514, the location information selector 157 determines whether the indoor location information determination modules are capable of providing the indoor location information, i.e., if the indoor location information can be determined.

If the indoor location information determination modules are not capable of providing the indoor location information to location information selector 157, provides the estimated location information to the application processor 159 in step 520.

However, if the indoor location information determination modules are capable of providing the indoor location information, in step 515, the location information selector 157 determines the indoor location information provided by the indoor location information determination modules and provides the indoor location information to the application processor 159. In step 516, the application processor 159 drives an application, such as Navigation or Geo-Tagging, using location information and provides data generated by the application together with the indoor location information.

According to an embodiment of the present invention, a method and apparatus for determining accuracy information for location information provides an environment in which a user can intuitively presume the reliability of location information provided in a shadow area.

In addition, the method and apparatus for determining accuracy information of location information may a switching criterion of indoor location information determination modules for determining indoor location information in a shadow area.

While certain embodiments of the present invention have been described above, various changes or modifications in form and details may be made therein without departing from the spirit and scope of the present invention as defined by the appended claims and their equivalents.

What is claimed is:

1. A method of determining accuracy information for location information, the method comprising:
receiving Global Positioning System (GPS) location information of a user terminal from a GPS;
determining whether the user terminal enters into a GPS shadow area;
checking terminal movement information including a moving speed and a moving direction of the user terminal, when the user terminal enters into the GPS shadow area;
estimating location information of the user terminal based on the terminal movement information;
checking auxiliary location information including a moving state of the user terminal, error information of a terrestrial magnetism sensor, and the moving speed of the user terminal;
determining an accumulated location error of the estimated location information based on the auxiliary location information; and
determining the accuracy information based on the accumulated location error of the estimated location information.

2. The method of claim 1, wherein the moving state of the user terminal includes information indicating whether the user terminal is parallel or orthogonal to a surface of the earth.

3. The method of claim 1, wherein the auxiliary location information further includes at least one of information selected from a dispersion value of the moving speed, a time difference of terminal location estimation, a moving time in the GPS shadow area, an angular velocity variance of a gyro sensor, an altitude variance, an error of an acceleration sensor, an error of the gyro sensor, and an error of an altimeter sensor.

4. The method of claim 1, further comprising:
comparing the accuracy information with a predetermined threshold; and
if the accuracy information is less than or equal to the predetermined threshold, providing the estimated location information as the location information.

5. The method of claim 4, further comprising, checking GPS location information and providing the GPS location information as the location information, when the accuracy information is greater than the predetermined threshold.

6. The method of claim 4, further comprising requesting and receiving indoor location information from indoor location information determination modules, and providing the indoor location information as the location information, when the accuracy information is greater than the predetermined threshold.

7. The method of claim 1, further comprising providing the estimated location information and the accuracy information together with data generated by an application.

8. An apparatus for determining accuracy information of location information, the apparatus comprising:
a shadow area determiner for receiving Global Positioning System (GPS) location information of a user terminal from a GPS and determining whether the user terminal enters into a GPS shadow area;
a location information estimator for checking terminal movement information including a moving speed and a moving direction of the user terminal and estimating location information of the user terminal based on the terminal movement information in the GPS shadow area; and
an accuracy estimator for checking auxiliary location information including a moving state of the user terminal, error information of a terrestrial magnetism sensor, and the moving speed of the user terminal, and determining the accuracy information based on an accumulated location error of the estimated location information, based on the auxiliary location information.

9. The apparatus of claim 8, wherein the auxiliary location information further comprises at least one of:
information selected from a dispersion value of the moving speed of the user;
a time difference of terminal location estimation;
a moving time in the GPS shadow area;
an angular velocity variance of a gyro sensor;
an altitude variance;
an error of an acceleration sensor;
an error of the gyro sensor; and
an error of an altimeter sensor.

10. The apparatus of claim 8, further comprising a location information selector for selecting the location information,
wherein the location information selector compares the accuracy information with a predetermined threshold, and if the accuracy is less than or equal to the predetermined threshold, provides the estimated location information as the location information.

11. The apparatus of claim 9, wherein, if the accuracy information is greater than the predetermined threshold, the location information selector provides the GPS location information as the location information.

12. The apparatus of claim 9, wherein, if the accuracy information is greater than the predetermined threshold, the location information selector receives indoor location information from indoor location information determination modules and provides the indoor location information as the location information.

13. The apparatus of claim 8, further comprising:
a location information selector for selecting the location information; and
an application processor for processing application data,
wherein the location information selector provides the estimated location information and the accuracy information to the application processor, and
the application processor provides the estimated location information and the accuracy information together with data generated by an application.

14. A user terminal comprising:
a location information determination module including a Global Positioning System (GPS) module for determining GPS location information of the user terminal from a GPS;
a sensor unit for sensing acceleration information and azimuth information for estimating location information in a GPS shadow area and accuracy information of the location information;
a controller for determining whether the user terminal enters into the GPS shadow area, estimating the location information of the user terminal in the GPS shadow area, checking auxiliary location information including a moving state of the user terminal, error information of a terrestrial magnetism sensor, and a moving speed of the user terminal, and determining the accuracy information based on an accumulated location error of the estimated location information, based on the auxiliary location information;
a memory for storing the GPS location information, the estimated location information, and the accuracy information generated by the location information determination module and the controller; and
a timer for generating an operation event signal at predetermined times and providing the operation event signal to the sensor unit and the controller.

15. The user terminal of claim 14, wherein the location information determination module comprises at least one of:
a Wi-Fi Positioning System (WPS) module for determining the location information by using information regarding a wireless Access Point (AP) through Wi-Fi;
a cell based location information providing module for providing the location information based on a cell of a mobile communication network; and
a sensor based location information providing module for providing the location information of the user terminal using sensors.

16. The user terminal of claim 14, wherein the sensor unit comprises at least one of:
an acceleration sensor for sensing acceleration information of the user terminal;
a terrestrial magnetism sensor for sensing azimuth information the user terminal;
an altimeter sensor for sensing altitude information of the user terminal; and
a gyro sensor for sensing angular velocity information.

17. The user terminal of claim 14, wherein the controller comprises:
a shadow area determiner for determining whether the user terminal enters into the GPS shadow area;
a location information estimator for checking terminal movement information including a moving speed and a moving direction of the user terminal and estimating location information of the user terminal based on the terminal movement information in the GPS shadow area; and
an accuracy estimator for checking auxiliary location information including the moving state of the user terminal, error information of a terrestrial magnetism sensor, and the moving speed of the user terminal, and determining the accuracy information.

18. The user terminal of claim 15, further comprising a location information selector for selecting location information,
wherein the location information selector compares the accuracy information with a predetermined threshold, and if the accuracy information is less than or equal to the predetermined threshold, provides the estimated location information as the location information.

19. The user terminal of claim 18, wherein, if the accuracy information is greater than the predetermined threshold, the location information selector receives indoor location information from indoor location information determination modules, and provides the indoor location information as the location information.
